(19) United States
(12) Patent Application Publication
(10) Pub. No.: US 2025/0011523 A1
(43) Pub. Date: Jan. 9, 2025

(54) PREPOLYMER COMPOSITION, POLYURETHANE RESIN, ELASTIC MOLDED ARTICLE, AND PRODUCTION METHOD OF PREPOLYMER COMPOSITION

(71) Applicant: MITSUI CHEMICALS, INC., Tokyo (JP)

(72) Inventors: Kazuhiro MAEKAWA, Sodegaura-shi, Chiba (JP); Takuya HASHIGUCHI, Ichihara-shi, Chiba (JP)

(21) Appl. No.: 18/711,650

(22) PCT Filed: Jan. 17, 2023
(86) PCT No.: PCT/JP2023/001096

§ 371 Date: May 20, 2024

(30) Foreign Application Priority Data
Jan. 18, 2022 (JP) 2022-005728

(51) Int. Cl. C08G 18/75; C08G 18/10; C08G 18/44; C08J 5/24

(52) U.S. Cl. CPC C08G 18/757; C08G 18/10; C08G 18/44; C08J 5/24; C08J 2375/04

(57) ABSTRACT

A prepolymer composition contains an isocyanate group-terminated prepolymer. The isocyanate group-terminated prepolymer is a reaction product of a polyisocyanate component containing 1,4-bis(isocyanatomethyl)cyclohexane and a polyol component containing polycarbonate polyol. The 1,4-bis(isocyanatomethyl)cyclohexane contains a trans isomer at a ratio of 60% by mole or more. The polycarbonate polyol has a viscosity (V₁) at 80° C. of 4000 mPa·s or less. The prepolymer composition has a viscosity (V₂) at 80° C. of 4000 mPa·s or less. The prepolymer composition has an isocyanate group concentration of 8.0% by mass or more and less than 13.0% by mass.

### TECHNICAL FIELD

The present invention relates to a prepolymer composition, a polyurethane resin, an elastic molded article, and a method for producing a prepolymer composition.

### BACKGROUND ART

A polyurethane resin has, for example, a soft segment formed by reaction of polyisocyanate with a macropolyol, and a hard segment formed by reaction of polyisocyanate with a chain extender.

More specifically, a polyurethane resin obtained by the following method is known. That is, first, 1,4-bis(isocyanatomethyl)cyclohexane (H₆XDI) is allowed to react with polycarbonate diol (PCD2) containing 3-methyl-1,5-pentanediol and 1,6-hexanediol as constituent units to obtain a urethane prepolymer. The urethane prepolymer is then allowed to react with 1,4-butanediol to obtain a polyurethane resin (see, for example, Patent Document 1 (Example 2)).

It is also known, for example, that the use of 1,4-bis(isocyanatomethyl)cyclohexane containing a trans isomer at a relatively high ratio in a polyurethane resin improves various mechanical properties.

More specifically, a polyurethane resin for elastic molding obtained by reaction of a polyisocyanate component containing 1,4-bis(isocyanatomethyl)cyclohexane including 80% by mole or more of trans isomers with an active hydrogen compound has been proposed (see, for example, Patent Document 2 (paragraphs [0291] to [0300]).

### CITATION LIST

### Patent Documents

Patent Document 1: Japanese Unexamined Patent Publication No. 2021-134464
Patent Document 2: WO 2009/051114

### SUMMARY OF THE INVENTION

### Problem to be Solved by the Invention

On the other hand, the polyurethane resin described in Patent Document 1 do not have sufficient crack propagation resistance. Therefore, the polyurethane resin is required to have, in addition to excellent mechanical properties, excellent crack propagation resistance.

However, in order to obtain a polyurethane resin having excellent crack propagation resistance as well as excellent mechanical properties, as described in Patent Document 2 (paragraphs [0291] to [0300]), when the ratio of the trans isomer of 1,4-bis(isocyanatomethyl)cyclohexane is increased, the tensile strength at break (TS) as mechanical properties increases but the elongation at break (EL) decreases. In such a case, the crack propagation resistance usually decreases as well along with the decrease of the elongation at break (EL).

The present invention provides a prepolymer composition capable of producing a polyurethane resin having excellent crack propagation resistance and mechanical properties, a polyurethane resin obtained using the prepolymer composition, an elastic molded article including the polyurethane resin, and a method for producing a prepolymer composition.

### Means for Solving the Problem

The present invention [1] includes a prepolymer composition containing an isocyanate group-terminated prepolymer, in which the isocyanate group-terminated prepolymer is a reaction product of a polyisocyanate component containing 1,4-bis(isocyanatomethyl)cyclohexane and a polyol component containing polycarbonate polyol, the 1,4-bis(isocyanatomethyl)cyclohexane contains a trans isomer at a ratio of 60% by mole or more, the polycarbonate polyol has a viscosity (V₁) at 80° C. of 4000 mPa·s or less, the prepolymer composition has a viscosity (V₂) at 80° C. of 4000 mPa·s or less, and the prepolymer composition has an isocyanate group concentration of 8.0% by mass or more and less than 13.0% by mass.

The present invention [2] includes the prepolymer composition described in [1], in which the prepolymer composition contains the isocyanate group-terminated prepolymer; and an isocyanate monomer containing 1,4-bis(isocyanatomethyl)cyclohexane.

The present invention [3] includes a polyurethane resin containing a reaction product of the prepolymer composition described in [1] or [2] and a chain extender.

The present invention [4] includes an elastic molded article containing the polyurethane resin described in [3].

The present invention [5] includes a method for producing a prepolymer composition, including a preparation step of preparing a polyisocyanate component containing the 1,4-bis(isocyanatomethyl)cyclohexane and a polyol component containing polycarbonate polyol; and a prepolymer preparation step of preparing a reaction product liquid containing an isocyanate group-terminated prepolymer by allowing the polyisocyanate component to react with the polyol component at such a ratio that an equivalent ratio (NCO/OH) of an isocyanate group in the polyisocyanate component to a hydroxy group in the polyol component exceeds 1.0, the 1,4-bis(isocyanatomethyl)cyclohexane contains a trans isomer at a ratio of 60% by mole or more, the polycarbonate polyol has a viscosity (V₁) at 80° C. of 4000 mPa·s or less, the prepolymer composition has a viscosity (V₂) at 80° C. of 4000 mPa·s or less, an increase ratio (V₂/V₁) of the viscosity (V₂) at 80° C. of the prepolymer composition to the viscosity (V₁) at 80° C. of the polycarbonate polyol is 2.0 or less, and the prepolymer composition has an isocyanate group concentration of 8.0% by mass or more and less than 13.0% by mass.

### Effects of the Invention

In the prepolymer composition of the present invention, the 1,4-bis(isocyanatomethyl)cyclohexane in the polyisocyanate component contains a trans isomer at a relatively high ratio, and the polycarbonate polyol in the polyol component has a relatively low viscosity. Further, the prepolymer composition has a relatively low viscosity. In addition, the prepolymer composition has an isocyanate group concentration in a predetermined range. Such prepolymer composition can produce a polyurethane resin having excellent crack propagation resistance and excellent mechanical properties.

Since the polyurethane resin and elastic molded article of the present invention are obtained using the above-described prepolymer composition, they have excellent crack propagation resistance and excellent mechanical properties.

The method for producing a prepolymer according to the present invention can produce the above-described prepolymer composition.

### DESCRIPTION OF THE EMBODIMENTS

The prepolymer composition of the present invention contains an isocyanate group-terminated prepolymer. The isocyanate group-terminated prepolymer is a reaction product of a polyisocyanate component and a polyol component. In the following, the prepolymer composition and a method for producing the prepolymer composition according to the present invention will be described in detail.

In the production of the prepolymer composition, first, a polyisocyanate component and a polyol component are prepared (preparation step).

The polyisocyanate component contains 1,4-bis(isocyanatomethyl)cyclohexane (1,4-H₆XDI) as an essential component.

The 1,4-bis(isocyanatomethyl)cyclohexane has cis-1,4-bis(isocyanatomethyl)cyclohexane and trans-1,4-bis(isocyanatomethyl)cyclohexane as stereoisomers. That is, the bis(isocyanatomethyl)cyclohexane preferably contains cis-1,4-bis(isocyanatomethyl)cyclohexane and trans-1,4-bis(isocyanatomethyl)cyclohexane. In the following, the cis-1,4-bis(isocyanatomethyl)cyclohexane may be referred to as cis-1,4 isomer. The trans-1,4-bis(isocyanatomethyl)cyclohexane may be referred to as trans-1,4 isomer. A total amount of the trans-1,4 isomer and the cis-1,4 isomer is 100% by mole.

The 1,4-bis(isocyanatomethyl)cyclohexane contains the trans-1,4 isomer. In the 1,4-bis(isocyanatomethyl)cyclohexane, the content ratio of the trans-1,4 isomer is 60% by mole or more, preferably 70% by mole or more, more preferably 80% by mole or more, further preferably 85% by mole or more. In the 1,4-bis(isocyanatomethyl)cyclohexane, the content ratio of the trans-1,4 isomer is, for example, 100% by mole or less, preferably 99.8% by mole or less, more preferably 99% by mole or less, further preferably 96% by mole or less, particularly preferably 90% by mole or less.

In the 1,4-bis(isocyanatomethyl)cyclohexane, the content ratio of the cis-1,4 isomer is, for example, 0% by mole or more, preferably 0.2% by mole or more, more preferably 1% by mole or more, further preferably 4% by mole or more, particularly preferably 10% by mole or more. In the 1,4-bis(isocyanatomethyl)cyclohexane, the content ratio of the cis-1,4 isomer is 40% by mole or less, preferably 30% by mole or less, more preferably 20% by mole or less, further preferably 15% by mole or less.

As long as the content ratio of the trans-1,4 isomer and the content ratio of the cis-1,4 isomer are within the above-described ranges, and the polyol component to be described later is used, a polyurethane resin having excellent crack propagation resistance and excellent mechanical properties is obtained.

The 1,4-bis(isocyanatomethyl)cyclohexane may be a modified product without inhibiting the excellent effect of the present invention. Examples of the modified product include uretdione-modified product, isocyanurate-modified product, iminooxadiazinedione, biuret-modified product, allophanate-modified product, polyol adduct, oxadiazinetrione-modified product, and carbodiimide-modified product. Preferably, the 1,4-bis(isocyanatomethyl)cyclohexane is not a modified product but a monomer (1,4-bis(isocyanatomethyl)cyclohexane monomer).

The polyisocyanate component can also contain another polyisocyanate as an optional component without inhibiting the excellent effect of the present invention.

The other polyisocyanate is a polyisocyanate except the 1,4-bis(isocyanatomethyl)cyclohexane. More specifically, examples of the other polyisocyanate include an aliphatic polyisocyanate, an alicyclic polyisocyanate (except 1,4-bis(isocyanatomethyl)cyclohexane), an aromatic polyisocyanate, and an araliphatic polyisocyanate. Examples of the aliphatic polyisocyanate include pentamethylene diisocyanate (PDI) and hexamethylene diisocyanate (HDI). Examples of the alicyclic polyisocyanate include 1,3-bis(isocyanatomethyl)cyclohexane (1,3-H₆XDI), isophorone diisocyanate (IPDI), norbornene diisocyanate (NBDI), and methylene bis(cyclohexyl isocyanate) (H₁₂MDI). Examples of the aromatic polyisocyanate include tolylene diisocyanate (TDI), diphenylmethane diisocyanate (MDI), toluidine diisocyanate (TODI), and naphthalene diisocyanate (NDI). Examples of the araliphatic polyisocyanate include xylylene diisocyanate (XDI) and tetramethylxylylene diisocyanate (TMXDI). The other polyisocyanate may be the above-described modified products without inhibiting the excellent effect of the present invention. These can be used alone or in combination of two or more.

The content ratio of the other polyisocyanate with respect to the total amount of the polyisocyanate component is, for example, 50% by mass or less, preferably 30% by mass or less, more preferably 10% by mass or less, particularly preferably 0% by mass from the viewpoint of crack propagation resistance. The content ratio of the bis(isocyanatomethyl)cyclohexane with respect to the total amount of the polyisocyanate component is, for example, 50% by mass or more, preferably 70% by mass or more, more preferably 90% by mass or more, particularly preferably 100% by mass from the viewpoint of mechanical properties.

That is, the polyisocyanate component preferably consists of 1,4-bis(isocyanatomethyl)cyclohexane.

The polyol component contains, as an essential component, a polycarbonate polyol having a relatively low viscosity (hereinafter referred to as a low-viscosity polycarbonate polyol). The term “relatively low viscosity” means a viscosity (V₁) at 80° C. of 4000 mPa·s or less. That is, the polyol component contains a polycarbonate polyol having a viscosity (V₁) at 80° C. of 4000 mPa·s or less.

The low-viscosity polycarbonate polyol contains, for example, a structural unit represented by the following formula (1).

—R¹—O—COO— (1)

(wherein R¹ represents a straight-chain alkylene group having 5 or more carbon atoms, a branched-chain alkylene group having 3 or more carbon atoms, or a polyoxyalkylene group.)

In the above-described formula (1), R¹ represents a straight-chain alkylene group having 5 or more carbon atoms, a branched-chain alkylene group having 3 or more carbon atoms, or a polyoxyalkylene group.

Examples of the straight-chain alkylene group having 5 or more carbon atoms include straight-chain alkylene groups having 5 to 20 carbon atoms. Examples of the straight-chain alkylene group having 5 to 20 carbon atoms include n-pentylene, n-hexylene, n-heptylene, n-octylene, n-nonylene, n-decylene, n-undecylene, n-dodecylene, n-tridecylene, n-tetradecylene, n-pentadecylene, n-hexadecylene, n-heptadecylene, n-octadecylene, n-nonadecylene, and n-icosylene. These are used alone or in combination of two or more.

Examples of the branched-chain alkylene group having 3 or more carbon atoms include branched-chain alkylene groups having 3 to 20 carbon atoms. Examples of the branched-chain alkylene group having 3 to 20 carbon atoms include 1,2-propylene, 1-methyl-1,3-propylene, 2-methyl-1,3-propylene, 1,1-dimethyl-1,3-propylene, 1,2-dimethyl-1,3-propylene, 1,3-dimethyl-1,3-propylene, 2,2-dimethyl-1,3-propylene, 1,2,3-trimethyl-1,3-propylene, 1,1,2-trimethyl-1,3-propylene, 1,2,2-trimethyl-1,3-propylene, 1,1,3-trimethyl-1,3-propylene, 1-methyl-1,4-butylene, 2-methyl-1,4-butylene, 1,1-dimethyl-1,4-butylene, 1,2-dimethylbutylene, 1,3-dimethyl-1,4-butylene, 1,4-dimethyl-1,4-butylene, 2,2-dimethyl-1,4-butylene, 2,3-dimethyl-1,4-butylene, 1,2,3-trimethyl-1,4-butylene, 1,2,4-trimethyl-1,4-butylene, 1,1,2-trimethyl-1,4-butylene, 1,2,2-trimethyl-1,4-butylene, 1,3,3-trimethyl-1,4-butylene, 1-methyl-1,5-pentylene, 2-methyl-1,5-pentylene, 3-methyl-1,5-pentylene, 1-methylhexylene, 2-methylhexylene, 3-methyl-1,6-hexylene, 2-methyl-1,8-octylene, 2-butyl-2-ethyl-1,3-propylene, and 2,2,4-trimethyl-1,6-hexylene. These are used alone or in combination of two or more.

In the polyoxyalkylene group, examples of the oxyalkylene include oxyalkylenes having 2 to 4 carbon atoms. Examples of the oxyalkylene having 2 to 4 carbon atoms include oxyethylene, oxypropylene (oxy-1,2-propylene), oxytrimethylene (oxy-1,3-propylene), and oxytetramethylene. Examples of the polyoxyalkylene group consisting of oxyalkylene having 2 to 4 carbon atoms include polyoxyethylene, polyoxypropylene, polyoxyethylene-polyoxypropylene (random and/or block copolymers), polyoxytrimethylene, and polyoxytetramethylene (PTM). These are used alone or in combination of two or more.

The number of repeating units of oxyalkylene is appropriately set so that the viscosity of the low-viscosity polycarbonate polyol is within a range to be described later. More specifically, the number of repeating units of oxyalkylene is, for example, 2 or more, preferably 3 or more. The number of repeating units of oxyalkylene is, for example, 60 or less, preferably 50 or less.

The number average molecular weight (in terms of polystyrene molecular weight determined by GPC) of the polyoxyalkylene group is appropriately set so that the viscosity of the low-viscosity polycarbonate polyol is within a range to be described later. More specifically, the number average molecular weight (in terms of polystyrene molecular weight determined by GPC) of the polyoxyalkylene group is, for example, 150 or more, preferably 250 or more. The number average molecular weight (in terms of polystyrene molecular weight determined by GPC) of the polyoxyalkylene group is, for example, 4000 or less, preferably 3000 or less.

In the above-described formula (1), R¹ is used alone or in combination of two or more. For example, as the low-viscosity polycarbonate polyol, a polycarbonate polyol having one kind of R¹ in a molecule (single-modified polycarbonate polyol) can be used alone.

As the low-viscosity polycarbonate polyol, a polycarbonate polyol having two or more kinds of R¹ in a molecule (combined-modified polycarbonate polyol) can be used alone.

Low-viscosity polycarbonate polyols having different R¹ from each other (single-modified polycarbonate polyol and/or combined-modified polycarbonate polyol) can also be used in combination of two or more (e.g., mixed use).

As R¹ in the above-described formula (1), preferably, a branched-chain alkylene group having 3 or more carbon atoms or a straight-chain polyoxyalkylene group having 2 or more carbon atoms are used.

In the low-viscosity polycarbonate polyol, the content ratio of the structural unit represented by the above-described formula (1) is appropriately adjusted so that the viscosity is within a range to be described later.

As necessary, the low-viscosity polycarbonate polyol can also contain a structural unit represented by the following formula (2) within a range satisfying a viscosity (V₁) to be described later.

—R²—O—COO— (2)

(wherein R² represents a straight-chain alkylene group having 4 or less carbon atoms or a cyclic alkylene group having 3 or more carbon atoms.)

In the above-described formula (2), R² represents a straight-chain alkylene group having 4 or less carbon atoms or a cyclic alkylene group having 3 or more carbon atoms.

Examples of the straight-chain alkylene group having 4 or less carbon atoms include straight-chain alkylene groups having 1 to 4 carbon atoms. Examples of the straight-chain alkylene group having 1 to 4 carbon atoms include methylene, ethylene, 1,3-propylene, and 1,4-butylene. These can be used alone or in combination of two or more.

Examples of the cyclic alkylene group having 3 or more carbon atoms include cycloalkylene groups having 3 to 8 carbon atoms. Examples of the cycloalkylene group having 3 to 8 carbon atoms include cyclopropylene, cyclobutylene, cyclopentylene, cyclohexylene, cycloheptylene, and cyclooctylene. These can be used alone or in combination of two or more.

In the low-viscosity polycarbonate polyol, the content ratio of the structural unit represented by the above-described formula (2) is appropriately adjusted so that the viscosity is within a range to be described later.

The low-viscosity polycarbonate polyol is obtained, for example, by copolymerization of alkylene carbonate and a polyhydric alcohol containing R¹ in the above-described formula (1). If necessary, the polyhydric alcohol containing R¹ in the above-described formula (1) and a polyhydric alcohol containing R² in the above-described formula (2) can be used together.

Examples of the alkylene carbonate include ethylene carbonate, propylene carbonate, and butylene carbonate. These can be used alone or in combination of two or more. As the alkylene carbonate, preferably, ethylene carbonate is used.

Examples of the polyhydric alcohol containing R¹ in the above-described formula (1) include dihydric alcohols containing R¹ in the above-described formula (1). Examples of the dihydric alcohol containing R¹ in the above-described formula (1) include straight-chain alkylene diols having 5 to 20 carbon atoms, branched-chain alkylene diols having 3 to 20 carbon atoms, and polyoxyalkylene diols. Examples of the straight-chain alkylene diol having 5 to 20 carbon atoms include 1,5-pentanediol, 1,6-hexanediol, 1,8-octanediol, and 1,10-decanediol. Examples of the branched-chain alkylene diol having 3 to 20 carbon atoms include 1,2-propanediol, 1,3-butanediol, 2,2-dimethyl-1,3-propanediol, 3-methyl-1,5-pentanediol, 2-methyl-1,8-octanediol, 2-butyl-2-ethylpropanediol, and 2,2,4-trimethyl-1,6-hexanediol. Examples of the polyoxyalkylene diol include polyoxyethylene glycol (PEG), polyoxypropylene glycol (PPG), and polytetramethylene ether glycol (PTMG). The number average molecular weight (Mn) of the polyoxyalkylene diol is appropriately set in accordance with its purpose and use. The number average molecular weight (in terms of polystyrene molecular weight determined by GPC) of the polyoxyalkylene diol is, for example, 150 or more, preferably 250 or more. The number average molecular weight (in terms of polystyrene molecular weight determined by GPC) of the polyoxyalkylene diol is, for example, 4000 or less, preferably 3000 or less.

The average number of hydroxy groups of the low-viscosity polycarbonate polyol is, for example, 2 or more and, for example, 4 or less, preferably 3 or less, particularly preferably 2. That is, as the low-viscosity polycarbonate polyol, preferably, a low-viscosity polycarbonate diol is used.

The number average molecular weight (in terms of polystyrene molecular weight determined by GPC) of the low-viscosity polycarbonate polyol is, for example, 400 or more, preferably 500 or more, more preferably 1000 or more. The number average molecular weight (in terms of polystyrene molecular weight determined by GPC) of the low-viscosity polycarbonate polyol is, for example, 5000 or less, preferably 4000 or less, more preferably 3000 or less.

The low-viscosity polycarbonate polyol has a relatively low viscosity. More specifically, the low-viscosity polycarbonate polyol has a viscosity (V₁) at 80° C. of 4000 mPa·s or less, preferably 3000 mPa·s or less, more preferably 2500 mPa·s or less, further preferably 2000 mPa·s or less, particularly preferably 1500 mPa·s or less. The low-viscosity polycarbonate polyol has a viscosity (V₁) at 80° C. of, for example, 10 mPa·s or more, preferably 50 mPa·s or more, more preferably 100 mPa·s or more, further preferably 500 mPa·s or more. The viscosity of the low-viscosity polycarbonate polyol is measured by a B type (cone-plate type) viscometer in accordance with Examples to be described later.

As long as the viscosity (V₁) at 80° C. of the low-viscosity polycarbonate polyol is within the above-described range, excellent pot life is obtained.

Further, as long as the viscosity (V₁) at 80° C. of the low-viscosity polycarbonate polyol is within the above-described range, and the content ratio of the trans-1,4 isomer in the 1,4-bis(isocyanatomethyl)cyclohexane is within the above-described range, a polyurethane resin having excellent crack propagation resistance and excellent mechanical properties is obtained.

The polyol component can contain, as an optional component, a polycarbonate polyol having a relatively high viscosity (hereinafter referred to as a high-viscosity polycarbonate polyol). The term “relatively low viscosity” means a viscosity (V₁) at 80° C. of above 4000 mPa·s, preferably 4500 or more. That is, the polyol component can contain a polycarbonate polyol having a viscosity (V₁) at 80° C. of above 4000 mPa·s.

The high-viscosity polycarbonate polyol can, for example, contain a structural unit represented by the above-described formula (1), and can also contain a structural unit represented by the above-described formula (2). In the high-viscosity polycarbonate polyol, the content ratio of the structural unit represented by the above-described formula (1) is appropriately adjusted so that the viscosity (V₁) at 80° C. exceeds 4000 mPa·s. In addition, in the high-viscosity polycarbonate polyol, the content ratio of the structural unit represented by the above-described formula (2) is appropriately adjusted so that the viscosity (V₁) at 80° C. exceeds 4000 mPa·s.

In the polyol component, the content ratio of the high-viscosity polycarbonate polyol is appropriately set without inhibiting the excellent effect of the present invention. More specifically, the content ratio of the high-viscosity polycarbonate polyol with respect to the total amount of the polyol component is, for example, 30% by mass or less, preferably 20% by mass or less, more preferably 10% by mass or less, particularly preferably 0% by mass. That is, the polyol component particularly preferably does not contain a high-viscosity polycarbonate polyol.

The polyol component can contain, as an optional component, another polyol (polyol except polycarbonate polyol). Examples of the other polyol include other macropolyols (macropolyols except polycarbonate polyol). The macropolyol is an organic compound having two or more hydroxy groups in a molecule and having a relatively high molecular weight. The term “relatively high molecular weight” means that the number average molecular weight is 400 or more, preferably 500 or more.

Examples of the other macropolyol include polyether polyol, polyester polyol, polyurethane polyol, epoxy polyol, vegetable oil polyol, polyolefin polyol, acrylic polyol, and vinyl monomer-modified polyol. These other macropolyols can be used alone or in combination of two or more.

In the polyol component, the content ratio of the other macropolyol is appropriately set without inhibiting the excellent effect of the present invention. More specifically, the content ratio of the other macropolyol with respect to the total amount of the polyol component is, for example, 30% by mass or less, preferably 20% by mass or less, more preferably 10% by mass or less, particularly preferably 0% by mass. That is, the polyol component particularly preferably does not contain any other macropolyol.

The polyol component can contain a low molecular weight polyol as an optional component. The low molecular weight polyol is an organic compound having two or more hydroxy groups in a molecule and having a relatively low molecular weight. The term “relatively low molecular weight” means that the number average molecular weight is less than 400, preferably 300 or less. That is, the molecular weight of the low molecular weight polyol is, for example, less than 400, preferably 300 or less. The molecular weight of the low molecular weight polyol is usually 40 or more.

Examples of the low molecular weight polyol include dihydric alcohols to be described later, trihydric alcohols to be described later, and tetra- or higher hydric alcohols to be described later. These can be used alone or in combination of two or more.

In the polyol component, the content ratio of the low molecular weight polyol is appropriately set without inhibiting the excellent effect of the present invention. More specifically, the content ratio of the low molecular weight polyol with respect to the total amount of the polyol component is, for example, 30% by mass or less, preferably 20% by mass or less, more preferably 10% by mass or less, particularly preferably 0% by mass. That is, the polyol component particularly preferably does not contain a low molecular weight polyol.

That is, the polyol component preferably consists of a low-viscosity polycarbonate polyol, and particularly preferably consists of a low-viscosity polycarbonate diol.

Then, in the production of the prepolymer composition, the above-described polyisocyanate component is allowed to react with the above-described polyol component to obtain a reaction product liquid containing an isocyanate group-terminated prepolymer (prepolymer preparation step).

The amounts of the polyisocyanate component and the polyol component blended are adjusted so that the amount of the isocyanate group in the polyisocyanate component exceeds the amount of the hydroxy group in the polyol component.

More specifically, in the prepolymer preparation step, an equivalent ratio (NCO/OH) of the isocyanate group in the polyisocyanate component to the hydroxy group in the polyol component is above 1.0, preferably 1.1 or more, more preferably 2.0 or more, further preferably 3.0 or more. The equivalent ratio (NCO/OH) of the isocyanate group in the polyisocyanate component to the hydroxy group in the polyol component is, for example, 5.0 or less, preferably 4.0 or less.

In the prepolymer preparation step, examples of the reaction method include bulk polymerization and solution polymerization.

In the bulk polymerization, for example, the polyisocyanate component is allowed to react with the polyol component under nitrogen flow. The reaction temperature is, for example, 50° C. or more. Further, the reaction temperature is, for example, 250° C. or less, preferably 200° C. or less. The reaction time is, for example, 0.5 hours or more, preferably 1 hour or more. Further, the reaction time is, for example, 15 hours or less.

In the solution polymerization, the polyisocyanate component is allowed to react with the polyol component in the presence of a known organic solvent. The reaction temperature is, for example, 50° C. or more. Further, the reaction temperature is, for example, 120° C. or less, preferably 100° C. or less. The reaction time is, for example, 0.5 hours or more, preferably 1 hour or more. Further, the reaction time is, for example, 15 hours or less.

In the prepolymer preparation step, for example, the above-described reaction is carried out until the isocyanate group concentration (NCO %) of the reaction product liquid (prepolymer composition) reaches a predetermined value (described later).

In the prepolymer preparation step, a known urethanizing catalyst may be added. Examples of the urethanizing catalyst include organometallic catalysts, amine catalysts, and potassium salts. These can be used alone or in combination of two or more. As the urethanizing catalyst, preferably, an organometallic catalyst is used.

Examples of the organometallic catalyst include organotin catalysts, organolead catalysts, organonickel catalysts, organocopper catalysts, and organobismuth catalysts. These can be used alone or in combination of two or more. As the organometallic catalyst, preferably, an organotin catalyst is used.

Examples of the organotin catalyst include tin acetate, tin octylate, tin oleate, tin laurylate, monobutyltin trioctate, dibutyltin diacetate, dimethyltin dilaurate, dibutyltin dilaurate, dibutyltin dimercaptide, dibutyltin maleate, dibutyltin dineodecanoate, dioctyltin dimercaptide, dioctyltin dilaurylate, and dibutyltin dichloride. These can be used alone or in combination of two or more. As the organotin catalyst, preferably, dibutyltin dilaurate is used.

The amount of the urethanizing catalyst added is not particularly limited and is appropriately set in accordance with its purpose and use. The timing of adding the urethanizing catalyst is not particularly limited. For example, in the prepolymer preparation step, the urethanizing catalyst can be added to the polyisocyanate component and/or the polyol component. Alternatively, in the prepolymer preparation step, the urethanizing catalyst can be added during mixing of the polyisocyanate component and the polyol component. Alternatively, the urethanizing catalyst can be added to the mixture (reaction mixture liquid) of the polyisocyanate component and the polyol component.

Alternatively, two or more of these are combined, and the urethanizing catalyst may be added thereto at two or more timings. A method of adding the urethanizing catalyst is not particularly limited, and for example, the urethanizing catalyst may be added at once or in portions.

In this manner, a reaction product liquid of the polyisocyanate component and the polyol component is obtained. More specifically, the reaction product liquid contains, for example, an isocyanate group-terminated prepolymer that is a reaction product of the polyisocyanate component and the polyol component, and a polyisocyanate component (polyisocyanate monomer) that is an unreacted raw material.

This reaction product liquid is a prepolymer composition containing an isocyanate group-terminated prepolymer. That is, in the prepolymer preparation step, the above-described reaction product liquid (reaction product liquid in the prepolymer preparation step) can be obtained as a prepolymer composition.

In the prepolymer composition (reaction product liquid), the content ratio of the isocyanate group-terminated prepolymer (reaction product) and the content ratio of the unreacted polyisocyanate component (polyisocyanate monomer) are not particularly limited and is, for example, a ratio at which the isocyanate group concentration is in a range to be described later. As necessary, a portion of the unreacted polyisocyanate component (polyisocyanate monomer) can also be removed from the reaction product liquid by a known method. Alternatively, as necessary, the unreacted polyisocyanate component (polyisocyanate monomer) can also be added to the reaction product liquid. Preferably, the isocyanate group concentration (NCO %) is adjusted by the blending amounts and reaction conditions of the polyisocyanate component and the polyol component in the prepolymer preparation step without removing or adding the unreacted polyisocyanate component (polyisocyanate monomer).

The isocyanate group concentration of the prepolymer composition is 8.0% by mass or more, preferably 9.0% by mass or more, more preferably 10.0% by mass or more, further preferably 11.0% by mass or more, particularly preferably 11.5% by mass or more from the viewpoint of mechanical properties. The isocyanate group concentration of the prepolymer composition is less than 13.0% by mass, preferably 12.9% by mass or less, more preferably 12.5% by mass or less, further preferably 12.2% by mass or less, particularly preferably 12.0% by mass or less from the viewpoint of crack propagation resistance. The isocyanate group concentration (isocyanate group content) can be determined by a known measurement method. Examples of the measurement method include titration with di-n-butylamine and FT-IR analysis (the same applies to the following).

The prepolymer composition has a relatively low viscosity. The prepolymer composition has a viscosity (V₂) at 80° C. of 4000 mPa·s or less, preferably 3500 mPa·s or less, more preferably 3000 mPa·s or less, further preferably 2000 mPa·s or less, further preferably 1000 mPa·s or less from the viewpoint of crack propagation resistance and mechanical properties. The viscosity (V₁) at 80° C. of the prepolymer composition is, for example, 10 mPa·s or more, preferably 50 mPa·s or more, more preferably 100 mPa·s or more, further preferably 300 mPa·s or more. The viscosity of the prepolymer composition is measured by a B type (cone-plate type) viscometer in accordance with Examples to be described later.

An increase ratio (V₂/V₁) of the viscosity (V₂) at 80° C. of the prepolymer composition to the viscosity (V₁) at 80° C. of the low-viscosity polycarbonate polyol is, for example, 2.0 or less, preferably 1.5 or less, more preferably 1.3 or less, further preferably 1.1 or less. The increase ratio (V₂/V₁) of the viscosity (V₂) at 80° C. of the prepolymer composition is, for example, 1.0 or more, preferably above 1.0, more preferably 1.05 or more.

As long as the increase ratio (V₂/V₁) of the viscosity (V₂) at 80° C. of the prepolymer composition to the viscosity (V₁) at 80° C. of the low-viscosity polycarbonate polyol is within the above-described range, the crack propagation resistance can be furthermore improved.

As necessary, the prepolymer composition can contain a known additive. Examples of the additive include an antioxidant, a heat-resistant stabilizer, a light-resistant stabilizer, an ultraviolet absorber, an antiblocking agent, a mold releasing agent, a pigment, a dye, a lubricant, a filler, a hydrolysis inhibitor, a rust inhibitor, and a bluing agent. The amount and timing of addition of the additive are appropriately set in accordance with its purpose and use.

According to the above-described method for producing a prepolymer, a prepolymer composition can be obtained.

In this prepolymer composition, the 1,4-bis(isocyanatomethyl)cyclohexane in the polyisocyanate component contains a trans isomer at a relatively high ratio, and the polycarbonate polyol in the polyol component has a relatively low viscosity. Further, the prepolymer composition has a relatively low viscosity. In addition, the prepolymer composition has an isocyanate group concentration in a predetermined range. Such prepolymer composition can produce a polyurethane resin having excellent crack propagation resistance and excellent mechanical properties.

That is, conventionally, the increase in the ratio of the trans isomer of the 1,4-bis(isocyanatomethyl)cyclohexane has resulted in reduced elongation rate of the polyurethane resin, leading to deterioration in crack propagation resistance as well in some cases.

In contrast to this, in the above-described prepolymer composition, a low-viscosity polycarbonate polyol is used, and in addition, the viscosity and isocyanate group concentration of the prepolymer composition are adjusted. Therefore, by increasing the ratio of the trans isomer of the 1,4-bis(isocyanatomethyl)cyclohexane, mechanical properties (e.g., hardness) can be improved, and by increasing the elongation rate of the polyurethane resin, the crack propagation resistance can be improved.

In the following, a method of obtaining a polyurethane resin using the above-described prepolymer composition will be described in detail. In this method, the above-described prepolymer composition is allowed to react with a chain extender to synthesize a polyurethane resin (chain extending step).

The chain extender is a curing agent for prepolymer compositions. Examples of the chain extender include low molecular weight compounds containing a plurality of (preferably two) active hydrogen groups (hydroxy group, amino group). More specifically, examples of the low molecular weight compound include low molecular weight polyols and low molecular weight polyamines. As the chain extender, preferably, a low molecular weight polyol is used. By using a low molecular weight polyol, a polyurethane resin having excellent mechanical properties is obtained.

Examples of the low molecular weight polyol include the above-described low molecular weight polyols. More specifically, examples of the low molecular weight polyol include dihydric alcohol, trihydric alcohol, and tetra- or higher hydric alcohol. Examples of the dihydric alcohol include ethylene glycol, 1,2-propanediol, 1,3-propanediol, 1,2-butanediol, 1,3-butanediol, 1,4-butanediol, 1,5-pentanediol, 1,6-hexanediol, neopentyl glycol, diethylene glycol, triethylene glycol, and dipropylene glycol. Examples of the trihydric alcohol include glycerin and trimethylolpropane. Examples of the tetra- or higher hydric alcohol include pentaerythritol and diglycerol. As the low molecular weight polyol, polymerization products obtained by addition polymerization of alkylene (C2-3) oxide with dihydric to tetrahydric alcohols so as to have a number average molecular weight of 400 or less are used. These can be used alone or in combination of two or more.

As the low molecular weight polyol, preferably, dihydric alcohol and trihydric alcohol are used, more preferably, dihydric alcohol is used, further preferably, 1,4-butanediol is used. That is, the low molecular weight polyol preferably contains 1,4-butanediol, and more preferably consists of 1,4-butanediol. In this manner, a polyurethane resin having excellent mechanical properties is obtained.

The prepolymer composition and the chain extender are blended at such a ratio that the equivalent ratio (active hydrogen group/NCO) of the active hydrogen group in the chain extender to the isocyanate group in the prepolymer composition is, for example, 0.85 or more, preferably 0.90 or more, more preferably 0.95 or more. The equivalent ratio (active hydrogen group/NCO) of the active hydrogen group in the chain extender to the isocyanate group in the prepolymer composition is, for example, 1.10 or less, preferably 1.20 or less, more preferably 1.10 or less, more preferably 1.00 or less, particularly preferably 0.98 or less.

In the chain extending step, for example, the prepolymer composition and the chain extender are mixed at the above-described ratio and then heated. The reaction temperature (curing temperature) in the chain extending step is, for example, 100° C. or more, preferably 110° C. or more. The reaction temperature (curing temperature) in the chain extending step is, for example, 140° C. or less, preferably 130° C. or less.

The reaction time (curing time) in the chain extending step is, for example, 10 hours or more, preferably 12 hours or more. The reaction time (curing time) in the chain extending step is, for example, 24 hours or less, preferably 18 hours or less.

In the chain extending step, the above-described urethanizing catalyst may be added. The amount of the urethanizing catalyst added is not particularly limited and is appropriately set in accordance with its purpose and use. The timing of adding the urethanizing catalyst is not particularly limited. For example, in the chain extending step, the urethanizing catalyst can be added to the prepolymer composition and/or chain extender. Alternatively, in the chain extending step, the urethanizing catalyst can be added during mixing of the prepolymer composition and the chain extender. Alternatively, two or more of these are combined, and the urethanizing catalyst may be added thereto at two or more timings. A method of adding the urethanizing catalyst is not particularly limited, and for example, the urethanizing catalyst may be added at once or in portions.

In this manner, a polyurethane resin is obtained as a reaction product of the prepolymer composition and the chain extender.

As necessary, the polyurethane resin can contain a known additive. Examples of the additive include an antioxidant, a heat-resistant stabilizer, a light-resistant stabilizer, an ultraviolet absorber, an antiblocking agent, a mold releasing agent, a pigment, a dye, a lubricant, a filler, a hydrolysis inhibitor, a rust inhibitor, and a bluing agent. The amount and timing of addition of the additive are appropriately set in accordance with its purpose and use.

Since the above-described polyurethane resin is obtained using the above-described prepolymer composition, it has excellent crack propagation resistance and excellent mechanical properties. Therefore, the polyurethane resin is suitably used as an elastic molded article (polyurethane elastomer).

Examples of the elastic molded article (polyurethane elastomer) include TPU (thermoplastic polyurethane elastomer) and TSU (thermosetting polyurethane elastomer). As the polyurethane elastomer, preferably, TSU (thermosetting polyurethane elastomer) is used.

More specifically, the elastic molded article (polyurethane elastomer) is obtained as a casting polyurethane elastomer. The casting polyurethane elastomer is obtained, for example, by thermally curing the mixture of the prepolymer composition and the chain extender in a molding die having a desired shape in the chain extending step.

As necessary, the elastic molded article (polyurethane elastomer) is subjected to a heat treatment. The heat treatment temperature is, for example, 50° C. or more, preferably 80° C. or more. Further, the heat treatment temperature is, for example, 200° C. or less, preferably 150° C. or less. The heat treatment time is, for example, 30 minutes or more, preferably 1 hour or more. Further, the heat treatment time is, for example, 30 hours or less, preferably 20 hours or less.

As necessary, the elastic molded article (polyurethane elastomer) is aged. The aging temperature is, for example, 10° C. or more, preferably 20° C. or more. Further, the aging temperature is, for example, 50° C. or less, preferably 40° C. or less. The aging time is, for example, 1 hour or more, preferably 10 hours or more. Further, the aging time is, for example, 50 days or less, preferably 30 days or less.

Since such elastic molded article is obtained using the above-described prepolymer composition, it has excellent crack propagation resistance and excellent mechanical properties.

Therefore, the elastic molded article (polyurethane elastomer) is suitably used in various applications. Examples of the applications of the polyurethane elastomer include transparent rigid plastics, waterproof materials, potting agents, ink, binder, films, sheets, bands, belts, shoe press belts, tubes, rollers, blades, speakers, sensors, outsoles, threads, fibers, nonwoven fabrics, cosmetics, shoe articles, heat insulating materials, sealants, tape materials, sealing materials, solar power generation members, robot members, android members, wearable members, clothing goods, sanitary goods, cosmetic articles, furniture articles, food packaging members, sports articles, leisure goods, medical supplies, nursing care articles, members for housing, audio members, lighting members, vibration-proof members, sound-proof members, daily necessities, miscellaneous goods, cushions, beddings, stress absorbers, stress relievers, automobile interior material, automobile exterior material, railway members, aircraft members, optical members, members for OA equipment, protecting members for surfaces of miscellaneous goods, semiconductor sealing materials, self-repairing materials, health equipment, glass lenses, toys, packings, cable sheaths, wire harnesses, telecommunication cables, automobile wires, computer wires, industrial goods, shock absorbing materials, semiconductor production articles, and bridge bearings.

### EXAMPLE

Next, the present invention is described with reference to Examples and Comparative Examples. The present invention is however not limited by the following Examples. All designations of “part” or “parts” and “%” mean part or parts by mass and % by mass, respectively, unless otherwise particularly specified. The specific numerical values in blending ratio (content ratio), property value, and parameter used in the following description can be replaced with upper limit values (numerical values defined as “or less” or “below”) or lower limit values (numerical values defined as “or more” or “above”) of corresponding numerical values in blending ratio (content ratio), property value, and parameter described in the above-described “DESCRIPTION OF THE EMBODIMENTS”.

### 1. Raw Materials

### <Polyisocyanate Component>

### Production Example 1 (1,4-H₆XDI, 93% by Mole of Trans Isomer)

As a raw material, 1,4-bis(aminomethyl)cyclohexane (manufactured by Mitsubishi Gas Chemical Company, Inc.) having a trans/cis ratio of 93/7 determined by ¹³C-NMR was used to perform cold/hot two-stage phosgenation method under pressure.

A pressurizing reactor with a jacket equipped with an electromagnetic induction stirrer, an automatic pressure control valve, a thermometer, a nitrogen inlet line, a phosgene inlet line, a condenser, and a material feed pump was charged with 2500 parts by mass of ortho dichlorobenzene. Then, 1425 parts by mass of phosgene was added thereto through the phosgene inlet line and stirring was started. Cold water was flowed through the jacket of the reactor to maintain the inner temperature at approximately 10° C. A solution prepared by dissolving 400 parts by mass of 1,4-bis(aminomethyl)cyclohexane in 2500 parts by mass of ortho-dichlorobenzene was fed thereto with the feed pump over 60 minutes for cold phosgenation at 30° C. or less under atmospheric pressure. After completion of phosgene feeding, a pale-brown slurry was formed in the flask.

Subsequently, the inside of the reactor was pressurized at 0.25 MPa while the temperature was increased to 140° C. in 60 minutes, followed by hot-phosgenation under a pressure of 0.25 MPa at a reaction temperature of 140° C. for 2 hours. During the hot-phosgenation reaction, 480 parts by mass of phosgene was replenished. The liquid in the flask was turned into a pale-brown, transparent solution during the hot-phosgenation reaction. After completion of the hot-phosgenation reaction, nitrogen gas was introduced at 100 to 140° C. with a flow rate of 100 L/hour for degassing. Next, the ortho-dichlorobenzene solvent was distilled off under reduced pressure, and thereafter, using a rectifying column equipped with a distillation tube filled with four elements of packing (manufactured by Sumitomo Heavy Industries Ltd., trade name: Sumitomo/Sulzer Labo Packing EX), a distillation column equipped with a reflux ratio control timer (manufactured by Sibata Scientific Technology Ltd., trade name: distillation column K type), and a condenser, the remainder was further rectified with refluxing in a glass flask under the conditions of 138 to 143° C. and 0.7 to 1 KPa, to produce 382 parts by mass of 1,4-H₆XDI. The resulting 1,4-H₆XDI had a purity, which was determined by gas chromatography, of 99.9%, a hue of 5 in APHA, and a trans/cis ratio, which was determined by ¹³C-NMR, of 93/7. It contained 19 ppm of hydrolyzable chlorine (HC).

### Production Example 2 (1,4-H₆XDI, 41% by Mole of Trans Isomer)

As a raw material, 1,4-bis(aminomethyl)cyclohexane (manufactured by Tokyo Chemical Industry Co., Ltd.) having a trans/cis ratio of 41/59 determined by ¹³C-NMR was used in the same manner as in Production Example 1 to produce 388 parts by mass of 1,4-bis(isocyanatomethyl)cyclohexane having a trans/cis ratio of 41/59. The resulting 1,4-H₆XDI had a purity, which was determined by gas chromatography, of 99.9%, a hue of 5 in APHA, and a trans/cis ratio, which was determined by ¹³C-NMR, of 41/59. It contained 22 ppm of HC.

### Production Example 3 (1,4-H₆XDI, 86% by Mole of Trans Isomer)

A four-neck flask equipped with a stirrer, a thermometer, a reflux tube, and a nitrogen inlet tube was charged with 865 parts by mass of 1,4-H₆XDI (93% by mole of trans isomer) of Production Example 1 and 135 parts by mass of 1,4-H₆XDI (41% by mole of trans isomer) of Production Example 2, and the mixture was stirred at room temperature for 1 hour under a nitrogen atmosphere. The resulting 1,4-H₆XDI had a purity, which was determined by gas chromatography, of 99.9%, a hue of 5 in APHA, and a trans/cis ratio, which was determined by ¹³C-NMR, of 86/14. It contained 19 ppm of HC.

### Production Example 4 (1,4-H₆XDI, 65% by Mole of Trans Isomer)

A four-neck flask equipped with a stirrer, a thermometer, a reflux tube, and a nitrogen inlet tube was charged with 462 parts by mass of 1,4-H₆XDI (93% by mole of trans isomer) of Production Example 1 and 538 parts by mass of 1,4-H₆XDI (41% by mole of trans isomer) of Production Example 2, and the mixture was stirred at room temperature for 1 hour under a nitrogen atmosphere. The resulting 1,4-H₆XDI had a purity, which was determined by gas chromatography, of 99.9%, a hue of 5 in APHA, and a trans/cis ratio, which was determined by ¹³C-NMR, of 65/35. It contained 19 ppm of HC.

### Production Example 5 (1,4-H₆XDI, 50% by Mole of Trans Isomer)

A four-neck flask equipped with a stirrer, a thermometer, a reflux tube, and a nitrogen inlet tube was charged with 173 parts by mass of 1,4-H₆XDI (93% by mole of trans isomer) of Production Example 1 and 827 parts by mass of 1,4-H₆XDI (41% by mole of trans isomer) of Production Example 2, and the mixture was stirred at room temperature for 1 hour under a nitrogen atmosphere. The resulting 1,4-H₆XDI had a purity, which was determined by gas chromatography, of 99.9%, a hue of 5 in APHA, and a trans/cis ratio, which was determined by ¹³C-NMR, of 50/50. It contained 19 ppm of HC.

### <Polyol Component>

### (1) Type

The following polycarbonate polyols were prepared.
G4672; trade name: DURANOL G4672 (Mn=2000), manufactured by Asahi Kasei Corporation
T5651; trade name: DURANOL T5651 (Mn=1000), manufactured by Asahi Kasei Corporation
T5652; trade name: DURANOL T5652 (Mn=2000), manufactured by Asahi Kasei Corporation
NL2010DB; trade name: BENEBiOL NL2010DB (Mn=2000), manufactured by Mitsubishi Chemical Corporation
NT1002; trade name: BENEBiOL NT1002 (Mn=1000), manufactured by Mitsubishi Chemical Corporation
C2090; trade name KURARAY POLYOL C2090 (Mn=2000), manufactured by Kuraray Co., Ltd.

### (2) Viscosity

The viscosity (V₁) at 80° C. of the polycarbonate polyol was measured using a B type (cone-plate type) viscometer on the conditions of 40P Cone and 188 rpm. The results are shown in Table 1. The R₁ and R₂ of the constituent units (formulas (1) and (2)) in each polycarbonate polyol and their ratios are also shown in Table 1.

### [Table 1]

TABLE 1

| | | Constituent unit | | | | | |
|---|---|---|---|---|---|---|---|
| Polycarbonate | Viscosity at 80° C. | | Molar | | Molar | | Molar |
| polyol | V₁ (mPa · s) | R1 | ratio | R1 | ratio | R2 | ratio |
| G4672 | 4500 | — | — | 1,6-hexylene | 3 | 1,4-butylene | 7 |
| T5651 | 600 | 1,5-pentylene | 5 | 1,6-hexylene | 5 | — | — |
| T5652 | 2600 | 1,5-pentylene | 5 | 1,6-hexylene | 5 | — | — |
| NL2010DB | 3000 | — | — | 1,10-decene | 1 | 1,4-butylene | 9 |
| NT1002 | 150 | — | — | PTM | 10 | — | — |
| | | | | (Mn250) | | | |
| C2090 | 1600 | 3-methyl- | 9 | 1,6-hexylene | 1 | — | — |
| | | 1,5-pentylene | | | | | |

In Table 1, PTM (Mn 250) refers to a polyoxytetramethylene group having a number average molecular weight of 250.

### <Chain Extender>

1,4-BG: 1,4-Butanediol (butylene glycol)

### Urethanizing Catalyst

DBTDL: Dibutyltin dilaurate

### 2. Prepolymer Composition and Polyurethane Resin

### Examples 1 to 7 and Comparative Examples 1 to 7

### (1) Prepolymer Preparation Step

Prepolymer preparation step

The polyisocyanate component and polyol component listed in Tables 2 to 5 were allowed to react at 80° C. under a nitrogen atmosphere until the isocyanate group concentration (after the prepolymer preparation step) reached the values listed in Tables 2 to 5.

The equivalent ratio R1 (NCO/OH) of the isocyanate group in the polyisocyanate component to the hydroxy group in the polyol component is shown in the tables.

The viscosity (V₂) at 80° C. of the prepolymer composition was measured using a B type (cone-plate type) viscometer on the conditions of 40P Cone and 188 rpm. The increase ratio (V₂/V₁) of the viscosity (V₂) at 80° C. of the prepolymer composition to the viscosity (V₁) at 80° C. of the polycarbonate polyol was calculated. The results are shown together in the tables.

### (2) Chain Extending Step

Dibutyltin dilaurate (urethanizing catalyst, DBTDL) was added to 100 parts by mass of the prepolymer composition at the ratios listed in Tables 2 to 5. The prepolymer composition and the chain extender were then blended at the equivalent ratios listed in Tables 2 to 5, mixed for 60 seconds, and defoamed under reduced pressure for 60 seconds at room temperature. Thereafter, the mixture was poured into a mold and cured on the curing conditions listed in Tables 2 to 5, followed by aging at 23° C. for 3 weeks. In this manner, a polyurethane resin was produced. More specifically, a casting polyurethane elastomer was produced by the above-described cast molding.

### 3. Evaluation

### (1) Pot Life

Pot life after mixing of the prepolymer composition and the chain extender was measured in accordance with JIS K 7301 (1995). The preheating temperature of the prepolymer composition and the chain extender was set at 80° C. The temperature of the thermostatic chamber was set at 80° C. The results are shown in the tables.

### (2) A Hardness

The Shore A hardness of the polyurethane resin was measured in accordance with JIS K 7312 (1996).

### (3) Tensile Property

The tensile property of the polyurethane resin was measured in accordance with JIS K 7312 (1996) using a universal tensile tester (205N, manufactured by INTESCO co., ltd.). That is, the polyurethane resin was cut to obtain a No. 3 dumbbell test piece. Then, 100% and 300% moduli (MPa), a tensile strength (MPa), and elongation (elongation at break, %) were measured on the conditions of a tensile speed of 500 mm/min.

### (4) Crack Propagation Resistance

The polyurethane resin was cut into a 25 mm wide×10 cm long×2 mm thick size piece to obtain a test piece. The crack propagation resistance of the test piece was evaluated using a De Mattia Flex Cracking Tester (FT-1500 Series, manufactured by Ueshima Seisakusho Co., Ltd.) in the following manner.

That is, first, a 1 mm initial crack was formed at an end of the test piece in the center position in the length direction of the test piece so as to be perpendicular to the face direction of the test piece with a cutter knife. The upper portion of the test piece was then fixed to a gripping jig of the De Mattia Flex Cracking Tester so that the portion where the initial crack was formed was centered between upper and lower gripping jigs. The lower portion of the test piece was gripped by a gripping jig that was reciprocable. The distance between the upper portion fixed to the gripping jig and the lower portion gripped by the gripping jig (i.e., length of the ungripped portion of the test piece) was adjusted to approximately 75 mm.

Thereafter, the test piece was subjected to a reciprocating bending motion at a temperature of 20° C. and a frequency of 5 Hz. The distance between the upper portion of the test piece fixed to the gripping jig and the lower portion of the test piece gripped by the gripping jig at the maximum bending was approximately 17 mm. The length that had propagated from the initial crack (crack length) was then divided by the number of bends. In this manner, the crack propagation resistance was evaluated.

### [Table 2]

TABLE 2

| No. | | Comp. Ex 1 | Comp. Ex 2 | Comp. Ex 3 | Comp. Ex 4 |
|---|---|---|---|---|---|
| Polyisocyanate | Type | 1,4-H6XDI | 1,4-H6XDI | 1,4-H6XDI | 1,4-H6XDI |
| component | Cis isomer/Trans isomer | 50/50 | 50/50 | 50/50 | 35/65 |
| | (molar ratio) | | | | |
| Polyol component | Type | G4672 | G4672 | T5651/T5652 | G4672 |
| | Combination ratio | 100/0 | 100/0 | 25/75 | 100/0 |
| | (molar ratio) | | | | |
| | Viscosity | 4500 | 4500 | 600/2600 | 4500 |
| | (80° C., mPa · s) | | | | |
| Prepolymer | Equivalent ratio (NCO/OH) | 3.3 | 4.1 | 3.7 | 4.1 |
| preparation step | NCO % (mass %) | 7.0 | 9.0 | 9.0 | 9.0 |
| Chain extender | Type | 1,4-BG | 1,4-BG | 1,4-BG | 1,4-BG |
| Urethanizing catalyst | (Type/ppm) | DBTDL/150 | DBTDL/150 | DBTDL/150 | DBTDL/150 |
| Chain extending step | r (OH/NCO) | 0.95 | 0.95 | 0.95 | 0.95 |
| | Curing temperature (° C.) | 110 | 110 | 110 | 130 |
| | Curing time (hour) | 16 | 16 | 16 | 16 |
| Prepolymer composition | Viscosity (80° C., mPa · s) | 4300 | 3800 | 3200 | 3800 |
| | Pot life (min) | 1.5 | 1.0 | 3.0 | 1.0 |
| Polyurethane resin | A Hardness | 95 | 97 | 92 | 98 |
| | 100% Modulus (MPa) | 16 | 18 | 10 | 19 |
| | 300% Modulus (MPa) | 26 | 30 | 16 | — |
| | Tensile strength (MPa) | 45 | 35 | 22 | 32 |
| | Elongation (%) | 400 | 340 | 330 | 280 |
| | Crack propagation | 2.00 | 3.00 | 1.30 | 3.50 |
| | resistance (μm/times) | | | | |

TABLE 3

| No. | | Ex. 1 | Ex. 2 | Ex. 3 |
|---|---|---|---|---|
| Polyisocyanate | Type | 1,4-H6XDI | 1,4-H6XDI | 1,4-H6XDI |
| component | Cis isomer/Trans isomer | 35/65 | 14/86 | 7/93 |
| | (molar ratio) | | | |
| Polyol component | Type | T5651/T5652 | T5651/T5652 | T5651/T5652 |
| | Combination ratio | 27/73 | 27/73 | 27/73 |
| | (molar ratio) | | | |
| | Viscosity | 600/2600 | 600/2600 | 600/2600 |
| | (80° C., mPa · s) | | | |
| Prepolymer | Equivalent ratio (NCO/OH) | 3.7 | 3.7 | 3.7 |
| preparation step | NCO % (mass %) | 9.0 | 9.0 | 9.0 |
| Chain extender | Type | 1,4-BG | 1,4-BG | 1,4-BG |
| Urethanizing catalyst | (Type/ppm) | DBTDL/150 | DBTDL/150 | DBTDL/150 |
| Chain extending step | r (OH/NCO) | 0.95 | 0.95 | 0.95 |
| | Curing temperature (° C.) | 110 | 110 | 110 |
| | Curing time (hour) | 16 | 16 | 16 |
| Prepolymer composition | Viscosity (80° C., mPa · s) | 3200 | 3200 | 3200 |
| | Pot life (min) | 3.0 | 3.0 | 3.0 |
| Polyurethane resin | A Hardness | 94 | 95 | 96 |
| | 100% Modulus (MPa) | 12 | 13 | 14 |
| | 300% Modulus (MPa) | 24 | 25 | 26 |
| | Tensile strength (MPa) | 47 | 50 | 53 |
| | Elongation (%) | 320 | 320 | 320 |
| | Crack propagation | 0.60 | 0.50 | 0.50 |
| | resistance (μm/times) | | | |

TABLE 4

| No. | | Ex. 4 | Ex. 5 | Ex. 6 | Ex. 7 |
|---|---|---|---|---|---|
| Polyisocyanate | Type | 1,4-H6XDI | 1,4-H6XDI | 1,4-H6XDI | 1,4-H6XDI |
| component | Cis isomer/Trans isomer | 14/86 | 14/86 | 14/86 | 14/86 |
| | (molar ratio) | | | | |
| Polyol component | Type | NL2010DB | NL2010DB | NT1002 | C2090 |
| | Combination ratio | 100/0 | 100/0 | 100/0 | 100/0 |
| | (molar ratio) | | | | |
| | Viscosity | 3000 | 3000 | 150 | 1600 |
| | (80° C., mPa · s) | | | | |
| Prepolymer | Equivalent ratio (NCO/OH) | 4.1 | 4.6 | 3.4 | 4.1 |
| preparation step | NCO % (mass %) | 9.0 | 10.0 | 12.0 | 9.0 |
| Chain extender | Type | 1,4-BG | 1,4-BG | 1,4-BG | 1,4-BG |
| Urethanizing catalyst | (Type/ppm) | DBTDL/150 | DBTDL/150 | DBTDL/150 | DBTDL/150 |
| Chain extending step | r (OH/NCO) | 0.95 | 0.95 | 0.95 | 0.95 |
| | Curing temperature (° C.) | 110 | 110 | 110 | 110 |
| | Curing time (hour) | 16 | 16 | 16 | 16 |
| Prepolymer composition | Viscosity (80° C., mPa · s) | 3500 | 3000 | 300 | 1700 |
| | Pot life (min) | 3.5 | 3.0 | 5.0 | 5.0 |
| Polyurethane resin | A Hardness | 95 | 96 | 95 | 94 |
| | 100% Modulus (MPa) | 12 | 13 | 14 | 13 |
| | 300% Modulus (MPa) | 23 | 25 | 22 | 16 |
| | Tensile strength (MPa) | 45 | 47 | 45 | 40 |
| | Elongation (%) | 530 | 500 | 520 | 610 |
| | Crack propagation | 0.05 | 0.30 | 0.01 | 0.01 |
| | resistance (μm/times) | | | | |

TABLE 5

| No. | | Comp. Ex 5 | Comp. Ex 6 | Comp. Ex 7 |
|---|---|---|---|---|
| Polyisocyanate | Type | 1,4-H6XDI | 1,4-H6XDI | 1,4-H6XDI |
| component | Cis isomer/Trans isomer | 14/86 | 14/86 | 14/86 |
| | (molar ratio) | | | |
| Polyol component | Type | NL2010DB | C2090 | C2090 |
| | Combination ratio | 100/0 | 100/0 | 100/0 |
| | (molar ratio) | | | |
| | Viscosity | 3000 | 1600 | 1600 |
| | (80° C., mPa · s) | | | |
| Prepolymer | Equivalent ratio (NCO/OH) | 3.2 | 3.2 | 3.2 |
| preparation step | NCO % (mass %) | 7.0 | 7.0 | 13.0 |
| Chain extender | Type | 1,4-BG | 1,4-BG | 1,4-BG |
| Urethanizing catalyst | (Type/ppm) | DBTDL/150 | DBTDL/150 | DBTDL/150 |
| Chain extending step | r (OH/NCO) | 0.95 | 0.95 | 0.95 |
| | Curing temperature (° C.) | 110 | 110 | 110 |
| | Curing time (hour) | 16 | 16 | 16 |
| Prepolymer composition | Viscosity (80° C., mPa · s) | 4500 | 3000 | 1000 |
| | Pot life (min) | 6.5 | 7.0 | 2.0 |
| Polyurethane resin | A Hardness | 90 | 90 | 98 |
| | 100% Modulus (MPa) | 10 | 9 | 18 |
| | 300% Modulus (MPa) | 14 | 12 | 31 |
| | Tensile strength (MPa) | 43 | 38 | 35 |
| | Elongation (%) | 580 | 690 | 310 |
| | Crack propagation | 0.03 | 0.01 | 1.00 |
| | resistance (μm/times) | | | |

While the illustrative embodiments of the present invention are provided in the above-described invention, such is for illustrative purpose only and it is not to be construed restrictively. Modification and variation of the present invention that will be obvious to those skilled in the art is to be covered by the following claims.

### INDUSTRIAL APPLICABILITY

The prepolymer composition, polyurethane resin, elastic molded article, and method for producing a prepolymer composition according to the present invention are suitably used in various industrial fields where a polyurethane resin having excellent crack propagation resistance and mechanical properties is required.

1. A prepolymer composition comprising an isocyanate group-terminated prepolymer,
wherein the isocyanate group-terminated prepolymer is a reaction product of a polyisocyanate component comprising 1,4-bis(isocyanatomethyl)cyclohexane and a polyol component comprising polycarbonate polyol,
the 1,4-bis(isocyanatomethyl)cyclohexane comprising a trans isomer at a ratio of 60% by mole or more,
the polycarbonate polyol has a viscosity (V₁) at 80° C. of 4000 mPa·s or less,
the prepolymer composition has a viscosity (V₂) at 80° C. of 4000 mPa·s or less, and
the prepolymer composition has an isocyanate group concentration of 8.0% by mass or more and less than 13.0% by mass.

2. The prepolymer composition according to claim 1, wherein the prepolymer composition comprises the isocyanate group-terminated prepolymer; and an isocyanate monomer comprising 1,4-bis(isocyanatomethyl)cyclohexane.

3. A polyurethane resin comprising a reaction product of the prepolymer composition according to claim 1 and a chain extender.

4. An elastic molded article comprising the polyurethane resin according to claim 3.

5. A method for producing a prepolymer composition, comprising:
a preparation step of preparing a polyisocyanate component comprising the 1,4-bis(isocyanatomethyl)cyclohexane and a polyol component comprising polycarbonate polyol; and
a prepolymer preparation step of preparing a reaction product liquid comprising an isocyanate group-terminated prepolymer by allowing the polyisocyanate component to react with the polyol component at such a ratio that an equivalent ratio (NCO/OH) of an isocyanate group in the polyisocyanate component to a hydroxy group in the polyol component exceeds 1.0,
the 1,4-bis(isocyanatomethyl)cyclohexane comprising a trans isomer at a ratio of 60% by mole or more,
wherein the polycarbonate polyol has a viscosity (V₁) at 80° C. of 4000 mPa·s or less,
the prepolymer composition has a viscosity (V₂) at 80° C. of 4000 mPa·s or less,
an increase ratio (V₂/V₁) of the viscosity (V₂) at 80° C. of the prepolymer composition to the viscosity (V₁) at 80° C. of the polycarbonate polyol is 2.0 or less, and
the prepolymer composition has an isocyanate group concentration of 8.0% by mass or more and less than 13.0% by mass.
